(19) United States
(12) Patent Application Publication
(10) Pub. No.: US 2015/0026024 A1
(43) Pub. Date: Jan. 22, 2015

(54) SYSTEMS FOR MANAGING ACCOUNT AGGREGATORS ACCESS TO FINANCIAL ACCOUNT INFORMATION

(71) Applicant: Bank of America Corporation, Charlotte, NC (US)

(72) Inventors: Matthew A. Calman, Charlotte, NC (US); Dipika Jain, Charlotte, NC (US); Chris Purvis, Waxhaw, NC (US); William Kelley, Charlotte, NC (US); Michael E. Toth, Charlotte, NC (US)

(73) Assignee: Bank of America Corporation, Charlotte, NC (US)

(21) Appl. No.: 13/946,068

(22) Filed: Jul. 19, 2013

(51) Int. Cl. G06Q 40/02

(52) U.S. Cl. CPC G06Q 40/02
USPC 705/35

(57) ABSTRACT

Embodiments of the invention are directed to apparatus, methods, and computer program products for determining and notifying a user, herein a financial institution customer, as to which account aggregators currently have been granted permission to access accounts held by the customer at the financial institution. In addition to notifying the customer of the current status of account aggregator access, the present invention provides the customer, through an online or mobile banking application or the like, a comprehensive tool for managing the access granted to all of the account aggregators that are determined to currently have permission to access the customer's accounts.

### FIELD

In general, embodiments of the invention relate to methods, systems, apparatus and computer program products for managing financial accounts and, more particularly, for customer management of the account access to granted to account aggregators.

### BACKGROUND

Account aggregators are entities that, upon requests by users, access the users financial institution accounts, which may exist across multiple financial institutions (e.g., banks, brokerage firms and the like) and combine (i.e., aggregate) the data associated with such accounts, such as account balances, historical transaction data and the like. In addition, in certain instances, account aggregators may be authorized by the user to conduct financial transactions on behalf of the user, (e.g., pay bills, transfer funds and the like).

Typically, in today's Internet environment, account aggregators offer their services via websites, which allow users to sign-up for their services and provide authorization for the account aggregator to access the various financial accounts of the user held at one or more financial institutions. Once the various accounts have been accessed and the data aggregated, the websites provide the user with various different user interfaces (e.g., portals, dashboards and the like), which deliver charts, graphs, lists and the like of the aggregated account data. The user's management of the account access granted to the account aggregator is generally limited to the account aggregator's website, whereby a user must re-visit the account aggregator's website to change, limit or deny account access by the account aggregator. Additionally, in some instances, the account access granted to an account aggregator may be limited to an “all or nothing” approach, in which the account aggregator is granted “full” access to all accounts held by the customer at an authorized financial institution, with such “full” access allowing the account aggregator to access, and, in some instances, manage, financial accounts as the account aggregator deems necessary.

Problems exist when a user grants account access to an account aggregator and subsequently fails to use the service. Unbeknownst to the user, the account aggregator may still have access to the user's account at least in the short term and, in some instances, perpetually until the user actively revokes the access. Such data may be used by the account aggregator to compile demographic data that is available to other users. In addition, users that have granted account access to multiple different account aggregators may lose sight of which account aggregators they have authorized to access their accounts and/or the level of access that have been granted to the various different account aggregators.

Therefore, a need exists for a user of account aggregators to be made aware, on an ongoing basis, of which account aggregators currently have been granted permission to access the user's financial accounts held at a specific financial institution. Moreover, a need exists for a unified system that allows a financial institution customer to manage the account access granted to one, and in some instances various different, account aggregator(s).

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for determining and constantly notifying a user, herein a financial institution customer, as to which account aggregators currently have been granted permission to access accounts held by the customer at the financial institution. In addition to notifying the customer of the current status of account aggregator access, the present invention provides the customer, through an online or mobile banking application or the like, a comprehensive means for managing the access granted to all of the account aggregators that are determined to currently have permission to access the customer's accounts. Such managing of access includes, but is not limited to, granting full access, temporarily or permanently limiting access, temporarily or permanently denying access, and the like.

As such, the present invention serves to constantly make the financial institution customer aware of which account aggregators currently have permission to access the customer's account information. In addition, by providing the customer with a unified means for managing the access granted to the account aggregators, the customer is not required to visit multiple different account aggregator websites or otherwise contact the account aggregator to temporarily or permanently change the level of access granted to the account aggregator or, in some embodiments, temporarily or permanently deny access.

An apparatus for managing account aggregators' access to financial institution account data defines first embodiments of the invention. The apparatus includes a computing platform having a memory and at least one processor in communication with the memory device. The apparatus further includes an account aggregator management module that is stored in the memory and executable by the processor. The account aggregator management module is configured to determine which account aggregators currently have permission to access information associated with accounts held by a customer at a financial institution and, in response to the customer logging-on to an online or mobile banking application, display account aggregators indicators for each of the account aggregators determined to currently have permission to access the information associated with the accounts held by the customer at the financial institution. In addition, the account aggregator management module is further configured to provide one or more user interfaces within the online or mobile banking application that are configured to allow the customer to manage access provided to each of the account aggregators.

In specific embodiments of the apparatus, the account aggregator management module is further configured to provide the one or more user interfaces that are configured to allow the customer to set an access permission level (e.g., limited access or full access) for each of the account aggregators. In such embodiments of the apparatus, the account aggregator management module is further configured to provide the one or more user interfaces that are configured to allow the customer to select one or more access parameters for limited access permission. The access parameters may include, but are not limited to (1) access to customer designated accounts; (2) account balance access to customer designated accounts, (3) account transaction access to customer designated accounts, (4) engage in transactions on behalf of the customer from customer designated accounts and the like.

In still further specific embodiments of the apparatus, the account aggregator management module is configured to provide the one or more user interfaces that are configured to allow the customer to temporarily (for a customer designated period of time) or permanently add or temporarily (for a customer designated period of time) or permanently delete an account aggregator.

In still further specific embodiments of the apparatus, the account aggregator management module is configured to display the account aggregator indicators constantly during the online or mobile banking session, such as display of icons in an icon tray at the periphery (i.e., top, bottom or side) of the display. In such embodiments of the apparatus, the account aggregator management module is further configured to provide the customer access to the one or more user interfaces through activation of the account aggregator indicators (e.g., clicking-on an account aggregator icon or the like).

A method for managing account aggregators' access to financial institution account data defines second embodiments of the invention. The method includes determining, by a computing device processor, which account aggregators currently have permission to access information associated with accounts held by a customer at a financial institution. The method further includes, in response to the customer logging-on to an online or mobile banking application, displaying, by a computing device processor, account aggregators indicators for each of the account aggregators determined to currently have permission to access the information associated with the accounts held by the customer at the financial institution. In addition, the method includes providing, by a computing device processor, one or more user interfaces within the online or mobile banking application that are configured to allow the customer to manage access provided to each of the account aggregators.

In specific embodiments of the method, providing the user interfaces further includes providing, by the computing device processor, the one or more user interfaces that are configured to allow the customer to set an access permission level (e.g., full access or limited/partial access) for each of the account aggregators. In such embodiments of the invention the providing the one or more user interfaces further includes providing, by the computing device processor, the user interface that is configured to allow the customer to select one or more access parameters for limited access permission. The access parameters may include, but are not limited to (1) access to customer designated accounts; (2) account balance access to customer designated accounts, (3) account transaction access to customer designated accounts, (4) engage in transactions on behalf of the customer from customer designated accounts and the like.

In further specific embodiments of the method, providing the one or more user interfaces further includes providing, by the computing device processor, the one or more user interfaces that are configured to allow the customer to temporarily (for a customer designated period of time) or permanently add or temporarily (for a customer designated period of time) or permanently delete an account aggregator.

In further specific embodiments of the method, displaying further includes, displaying, by the computing device processor, the account aggregator indicators constantly during the online or mobile banking session, such as display of icons in an icon tray at the periphery (i.e., top, bottom or side) of the display. In such embodiments the method may further include providing, by a computing device processor, the customer access to the user interface through activation of the account aggregator indicators (e.g., clicking-on an account aggregator icon or the like).

A computer program product including a non-transitory computer-readable medium defines third embodiments of the invention. The computer-readable medium includes a first set of codes for causing a computer to monitor which account aggregators currently have permission to access information associated with accounts held by a customer at a financial institution. Additionally, the computer-readable medium includes a second set of codes for causing a computer to, in response to the customer logging-on to an online or mobile banking application, display account aggregators indicators for each of the account aggregators currently having permission to access the information associated with the accounts held by the customer at the financial institution. In addition, the computer-readable medium includes a third set of codes for causing a computer to provide a user interface within the online or mobile banking application that is configured to allow the customer to manage access provided to each of the account aggregators.

Thus, embodiments of the present invention, which are described in more detail below, provide for determining and continuously notifying a user, herein a financial institution customer, as to which account aggregators currently have been granted permission to access accounts held by the customer at the financial institution. In addition to notifying the customer of the current status of account aggregator access, the present invention provides the customer, through an online or mobile banking application or the like, a comprehensive means for managing the access granted to all of the account aggregators that are determined to currently have permission to access the customer's accounts. Such managing of access includes, but is not limited to, granting full access, temporarily or permanently limiting access, temporarily or permanently denying access, and the like.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a block diagram representation of an apparatus for managing account aggregators access to financial account information, in accordance with embodiments of the present invention;

FIG. 2 is a more detailed block diagram of an apparatus for managing account aggregators access to financial account information, in accordance with embodiments of the present invention;

FIG. 3 is a flow diagram of a method for managing account aggregators access to financial account information, in accordance with embodiments of the present invention; and

FIGS. 4-9 are schematic diagrams of user interfaces configured to provide account aggregator management, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “product” or “account” as used herein may include any financial product, service, or the like that may be provided to a customer from an entity that subsequently requires payment. A product may include an account, credit, loans, purchases, agreements, or the like between an entity and a customer. The term “relationship” as used herein may refer to any products, communications, correspondences, information, or the like associated with a customer that may be obtained by an entity while working with a customer. Customer relationship data may include, but is not limited to addresses associated with a customer, customer contact information, customer associate information, customer products, customer products in arrears, or other information associated with the customer's one or more accounts, loans, products, purchases, agreements, or contracts that a customer may have with the entity.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that utilized accounts in arrears recovery.

Thus, systems, apparatus, methods and computer program programs are herein described which provide determining and constantly notifying a user, herein a financial institution customer, as to which account aggregators currently have been granted permission to access accounts held by the customer at the financial institution. In addition to notifying the customer of the current status of account aggregator access, the present invention provides the customer, through an online or mobile banking application or the like, a comprehensive means for managing the access granted to all of the account aggregators that are determined to currently have permission to access the customer's accounts. Such managing of access includes, but is not limited to, granting full access, temporarily or permanently limiting access, temporarily or permanently denying access, and the like.

As such, the present invention serves to make the financial institution customer aware, on an on-going basis, of which account aggregators currently have permission to access the customer's account information. In addition, by providing the customer with a unified means for managing the access granted to the account aggregators, the customer is not required to visit multiple different account aggregator websites or otherwise contact the account aggregator to temporarily or permanently change the level of access granted to the account aggregator or, in some embodiments, temporarily or permanently deny access.

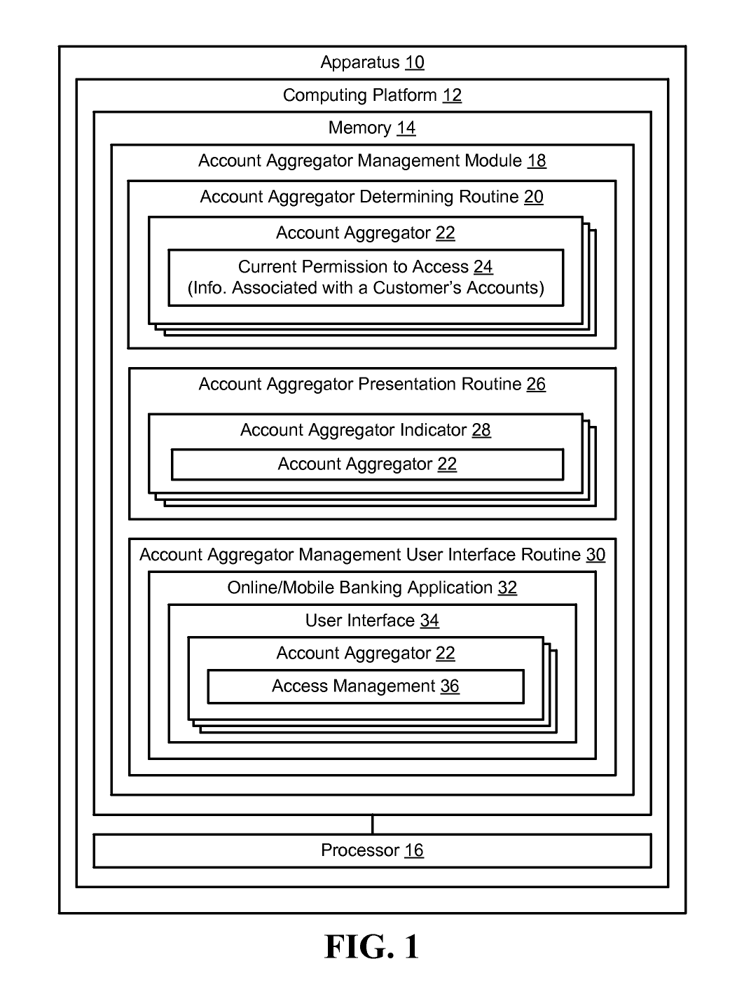

Referring to FIG. 1 a block diagram is depicted of an apparatus 10 for managing account aggregators access to a customer's financial account information, in accordance with embodiments of the present invention. The apparatus 10, which may include more than device, includes a computing platform 12 having a memory 14 which is in communication with processor 16.

Memory 14 stores account aggregator management module 18. The account aggregator management module 18 includes account aggregator determining module 20 that is configured to determine which account aggregators 22 currently have permission to access 24 information associated with a customer's financial institution accounts. An account aggregator 22 is an entity that combines information from a plurality of financial accounts held by a customer at one or more financial institutions. Account aggregators 22 may be third party entities (i.e., external to the financial institution at which accounts are held) or, in certain instances, may be internal entities within the financial institution. In specific embodiments, such determination may include monitoring and/or polling appropriate systems of record and tracking on a customer-basis to determine which account aggregators currently have permission to access 24 information associated with a customer's financial institution accounts. In specific embodiments, such determination may occur concurrently or proximate in time with a customer's log-in procedure for online or mobile banking to insure that the determination accurately reflects the account aggregators 22 that currently have permission to access 24 information associated with a customer's financial institution accounts 28.

Account aggregator module 18 additionally includes account aggregator presentation routine 26 that is configured to, in response to a customer logging-in to a networked based banking application, such as an online or mobile banking application, display account aggregator indicators 28 for each of the account aggregators 22 determined to currently have permission to access 24 the information associated with the customer's financial institution accounts. In specific embodiments, the indicators 28 may comprise a list of the account aggregators 22 displayed to the customer upon logging-in to the networked-based banking application.

In order to provide further security benefits, in specific embodiments of the invention, the customer log-in procedure may occur via a trusted device, such as a trusted mobile communication device or the like. An exemplary trusted mobile communication device and associated financial institution account log-in procedure is described in pending U.S. patent application Ser. No. 13/749,209, entitled “Enrollment of User in Device Authentication Program”, filed on Jan. 24, 2013, in the name of inventor Kelley, and assigned to the same inventive entity as the invention herein disclosed. U.S. patent application Ser. No. 13/749,209 is expressly incorporated by reference as if set forth fully herein.

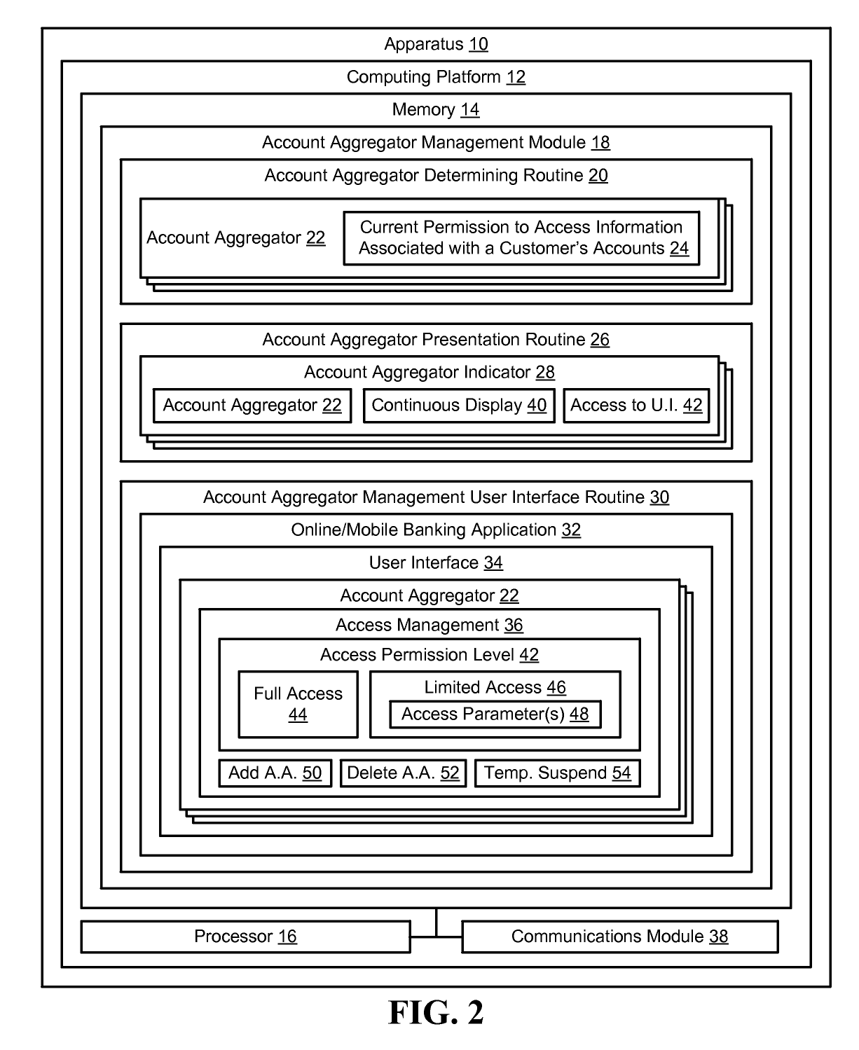

The account aggregator management module 18 additionally includes account aggregator management user interface (UI) routine 30 that is operable to provide a user interface 34 within the network-based banking application, such as online or mobile banking application 32 that is configured to allow the customer to manage access provided to each of the account aggregators 22. Access management 36 may include, but is not limited to, providing full access (i.e., all accounts and/or all functions capable of the account aggregator) or limited/partial access. In other embodiments, as discussed further in relation to FIGS. 2, 8 and 9, access management 36 may include permanently or temporarily adding an account aggregator, permanently and/or temporarily deleting an account aggregator. Thus, the user interface 34 provided by the present invention allows for the customer to view and manage access granted to account aggregators 33 at a single, comprehensive network site without having to be burdened with visiting each site controlled by each individual account aggregator 22.

Referring to FIG. 2 shown is a more detailed block diagram of apparatus 10, according to embodiments of the present invention. As previously described, the apparatus 10 is configured to provide customers of financial institutions access management over account aggregators, in accordance with embodiments of the present invention. In addition to providing greater detail, FIG. 2 highlights various alternate embodiments of the invention. The apparatus 10 may include one or more of any type of computerized device. The present apparatus and methods can accordingly be performed on any form or combination of computing devices, including servers, personal computing devices, laptop/portable computing devices, mobile computing devices or the like.

The apparatus 10 includes computing platform 12 that can receive and execute routines and applications. Computing platform 12 includes memory 14, which may comprise volatile and non-volatile memory, such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes processor 16, which may be an application-specific integrated circuit (“ASIC”), or other chipset, processor, logic circuit, or other data processing device. Processor 16 or other processor such as ASIC may execute an application programming interface (“API”) (not shown in FIG. 2) that interfaces with any resident programs, such as account aggregator management module 18, account aggregator determining routine 20. Account aggregator presentation routine 26, user interface routine 30 or the like stored in the memory 14 of the apparatus 10.

Processor 14 may include various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications and exchanging data with other networked devices. For the disclosed aspects, processing subsystems of processor 16 may include any subsystem used in conjunction with account aggregator management module 18 or subcomponents or sub-modules thereof.

Computer platform 12 additionally includes communications module 38 embodied in hardware, firmware, software, and combinations thereof, that enables communications among the various components of the apparatus 10. Thus, communication module 38 may include the requisite hardware, firmware, software and/or combinations thereof for establishing a network communication connection and initiating communication amongst networked devices.

As previously noted, the memory 16 of computing platform 12 stores account aggregator management module 18. The account aggregator management module 18 includes account aggregator determining module 20 that is configured to determine which account aggregators 22 currently have permission to access 24 information associated with a customer's financial institution accounts. In specific embodiments, such determination may include monitoring and/or polling appropriate systems of record and tracking on a customer-basis to determine which account aggregators currently have permission to access 24 information associated with a customer's financial institution accounts.

Account aggregator module 18 additionally includes account aggregator presentation routine 26 that is configured to, in response to a customer logging-in to a networked based banking application, such as an online or mobile banking application, display account aggregator indicators 28 for each of the account aggregators 22 determined to currently have permission to access 24 the information associated with the customer's financial institution accounts. In specific embodiments of the invention, the indicators 28 may comprise a list of the account aggregators 22 displayed to the customer upon logging-in to the networked-based banking application.

In other embodiments of the invention, the indicators 28 may be configured for continuous display 42, for example, icons continuously displayed in tray-format along the periphery (bottom, top or side) of the viewable-area of the display. In such embodiments in which the indicators 28 are configured for continuous display, such as icons or the like, a listing of the account aggregators may (or may not) be displayed to the customer at the onset of the online or mobile banking session. Continuous display 42 of the account aggregator indicators 32 serves as a constant reminder to the customer as to which account aggregators 22 currently have permission to access 28 information related to the customer's accounts.

Additionally, the indicators 32 may be configured as activatable links (i.e., hyperlinks or the like) that provide access to the user interface 34 configured to allow the customer to manage access provided to the account aggregators. In this regard, the customer may click-on or otherwise select/activate an account aggregator listed in the initial listing of account aggregators or click-on or otherwise select/activate an icon or other continuously display indicator to be provided a display of the user interface 38 for managing access provided to the associated account aggregator.

As previously discussed, the account aggregator management module 18 additionally includes account aggregator management user interface (UI) routine 30 that is operable to provide a user interface 34 within the network-based banking application, such as online or mobile banking application 32 that is configured to allow the customer to manage access provided to each of the account aggregators 22. Access management 36 may include, but is not limited to, providing for an access permission level 42, such as full access 44 (i.e., all accounts and/or all functions capable of the account aggregator) or limited/partial access 46. Limited access 46 may be defined by one or more access parameters 48 that are configured to be selected by the customer. The access parameters 48 may include, but are not limited to, access to a customer designated account, access to the account balance of a customer designated account, access to the historical transaction data associated with a customer designated account and/or authorization to engage in transactions (e.g., transfers, payments and the like) on behalf of the customer from customer designated accounts.

In other embodiments of the invention, access management 36 may provide for adding an account aggregator 50, deleting an account aggregator 52 or temporarily suspending 54 (or, in alternate embodiments, allowing) an account aggregator's access for a customer-designated time period.

In still further embodiments of the invention, the user interface(s) 34 may provide for aggregator contact information 56, such as a hyperlink to the aggregator's website or the like. Such contact information may be beneficial to the customer to readily access the account aggregator and make changes or delete access privileges granted to the account aggregator on the account aggregator side, so as to align with the changes currently being made at the financial institution side. In additional embodiments, the user interface 34 may indicate access information 58 associated with the aggregator, such as the last time the account aggregator accessed the customer's account information, the last transaction sent to the account aggregator (and associated time), the last transaction conducted by the account aggregator on behalf of the customer (and associated time) and the like.

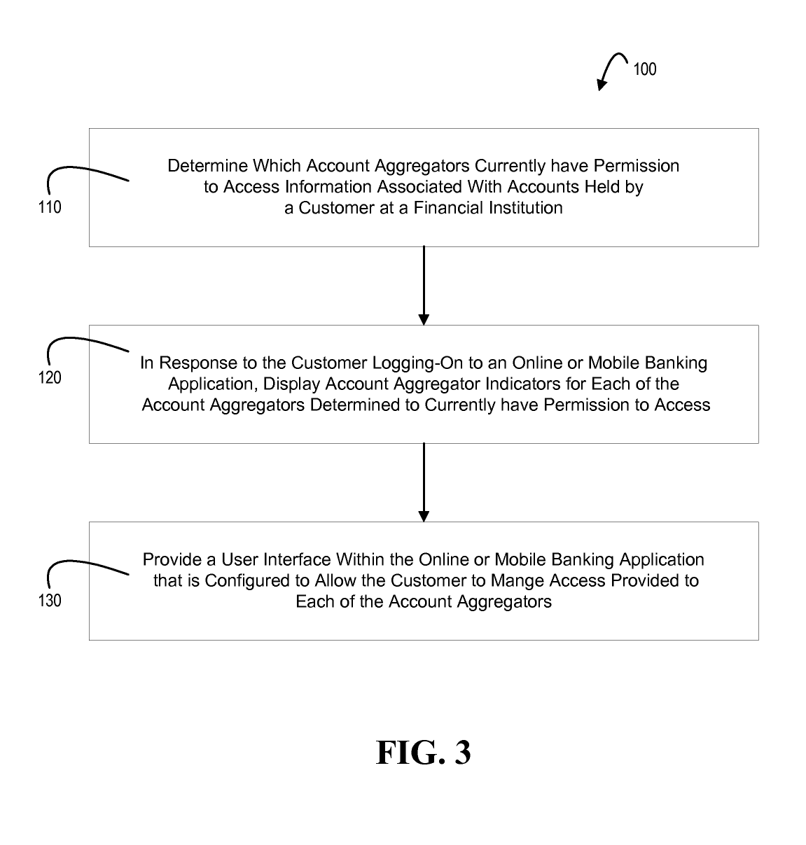

Referring to FIG. 3 a flow diagram is presented of a method 100 for managing account aggregator access to information associated with a customer's financial institution accounts, in accordance with embodiments of the present invention. At Event 110, a determination is made as to which account aggregators currently have permission to access information associated with accounts held by a customer at a financial institution. Account aggregators as defined herein are entities that, among other functions, combine information from a various financial accounts held by a customer at one, and typically more, financial institutions. The determination may be made by monitoring or polling systems of record to identify those account aggregators that currently have permission (as previously granted by the customer) to access the account information. In addition, once account aggregators are identified, a customer record, such as a customer profile or the like may indicate which account aggregators currently have permission to access the account information.

At Event 120, in response to the customer logging-in to a network-based banking application, such as mobile or online banking, account aggregator indicators are displayed (or otherwise communicated) to the customer. Each account aggregator indicator that is displayed is associated an account aggregator currently having permission to access the customer's account information. In specific embodiments of the method, the account aggregator indicators comprise a list of account aggregators that is displayed to the customer proximate in time to the customer logging-in to the mobile or online banking application. In other embodiments of the method, the account aggregator indicators may be displayed continuously throughout the customer's online or mobile banking session, for example, displayed as small icons in a tray-format on the periphery of the viewable area. In specific embodiments, the account aggregator indicators may be activated by the customer (such as be click-through or the like) to access the user interface(s) that provide the customer management over the access provided to the account aggregator associated with the corresponding indicator.

At Event 130, one or more user interfaces is provided within the network-based banking application that are configured to allow the customer to manage the access provided to each of the account aggregators. As previous noted the user interfaces may be accessible through activation of the account aggregator indicators and/or through menus provided within the network-based banking application. The user interfaces may be configured to manage access provided to the account aggregators by allowing the customer to set an access permission level for each of the account aggregators. In specific embodiments the method, the user interfaces may be configured to allow the customer to set the access permission levels as one of full access or limited (i.e., partial) access. In such embodiments of the method, the user interfaces may further be configured to allow the customer to select one or more access parameters that define the degree of limited access. For example, in specific embodiments, the customer may select from one or more access parameters including, but not limited to, (1) the accounts which the access aggregator may access (2) the type of information the access aggregator may access, for example, account balance data, historical transaction data, (3) authorization to engage in transactions (e.g., transfers, payments and the like) on behalf of the customer and the like.

In other embodiments of the method, user interfaces may be configured to manage access provided to the account aggregators by allowing the customer to permanently or temporarily add or delete an account aggregator. In those embodiments in which the customer may temporarily add or delete (i.e., suspend access) the user interface is further configured to allow the customer to select the time period for temporarily adding or suspending access to the account aggregator.

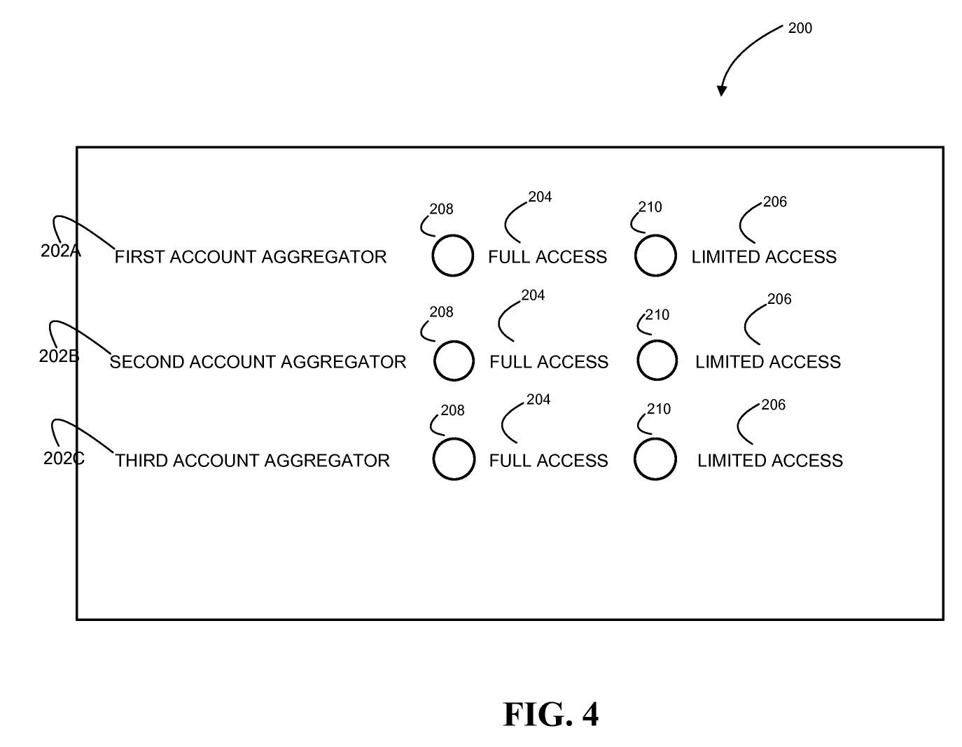

FIGS. 4-9 present exemplary user interfaces configured to allow a customer to manage account aggregator access to information associated with financial institution accounts held by the customer. It should be noted that the user interfaces shown in FIGS. 4-9 are merely simplified examples of user interfaces. Actual user interfaces may incorporate many more functions and details than the examples provided here.

FIG. 4 depicts user interface 200 which lists three different account aggregators 202; first account aggregator 202A, second account aggregator 202B and third account aggregator 202C. Account aggregators 202A-C have been determined to be those account aggregators which currently have permission to access information associated with financial institution accounts held by the customer. In the event additional account aggregators were determined to currently have permission to access the account information, the additional account aggregators would be displayed in user interface 200. In addition to listing the current account aggregators 202A-C having permission to access the account information, user interface 200 is configured to allow the customer to select an access permission level for each of the three account aggregators 202A-C. In the illustrated example of FIG. 4 the user interface 200 is configured to allow the customer to select full access 204 or limited access 206. Selection of the access permission level is made by possible by clicking-on or otherwise activating the associated circle 208 and 210. In other embodiments of the invention, the user interface 200 may be configured to allow the customer to select one of additional permission levels, such as, full/high access, medium access and/or low access.

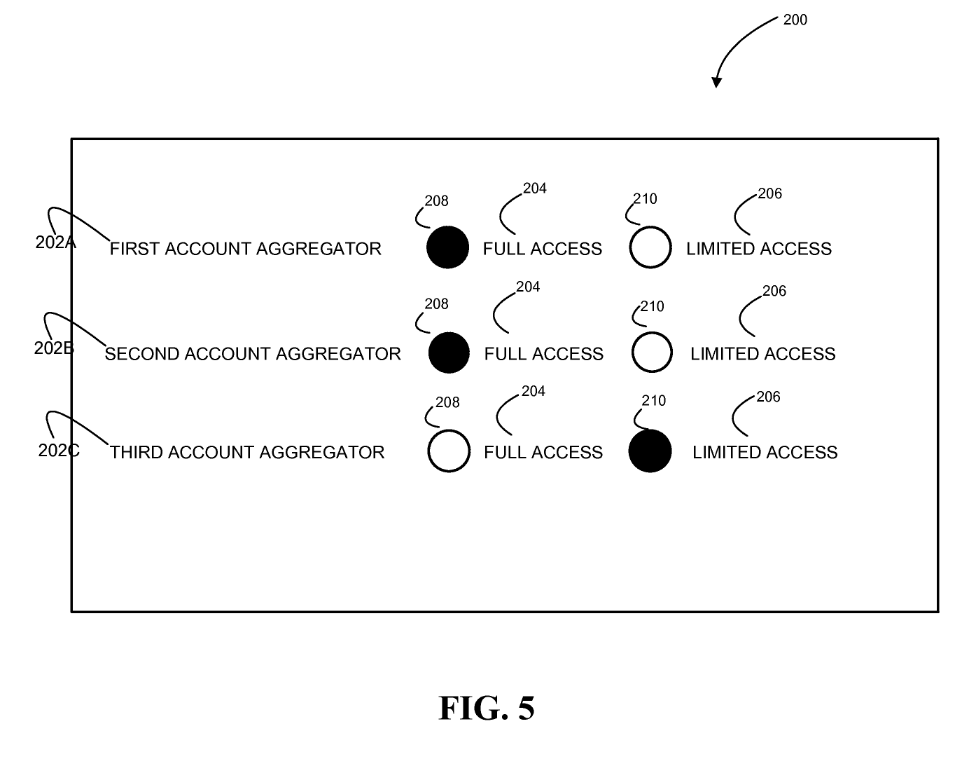

FIG. 5 depicts the same user interface 200 shown in FIG. 4 in which access permission levels have been selected for each of the account aggregators 202A-C. Specifically, full access has been selected for first account aggregator 202A and second account aggregator 202B and limited access has been selected for third account aggregator 202C. It should be noted that the user interface 200 shown in FIG. 5, in which an access permission level is designated, is the user interface that will initially be displayed to a customer. The designated access permission level may have been selected by the customer when they initially configured the account aggregator for access (typically at the account aggregator website or the like) or during a previous visit to the user interfaces within the online or mobile banking application. Once the current designated access permission is displayed, the customer can choose to change the permission level by activating the circle 208 or 210 associated with the permission level they desire (which, in turn, deactivates the current designated access permission).

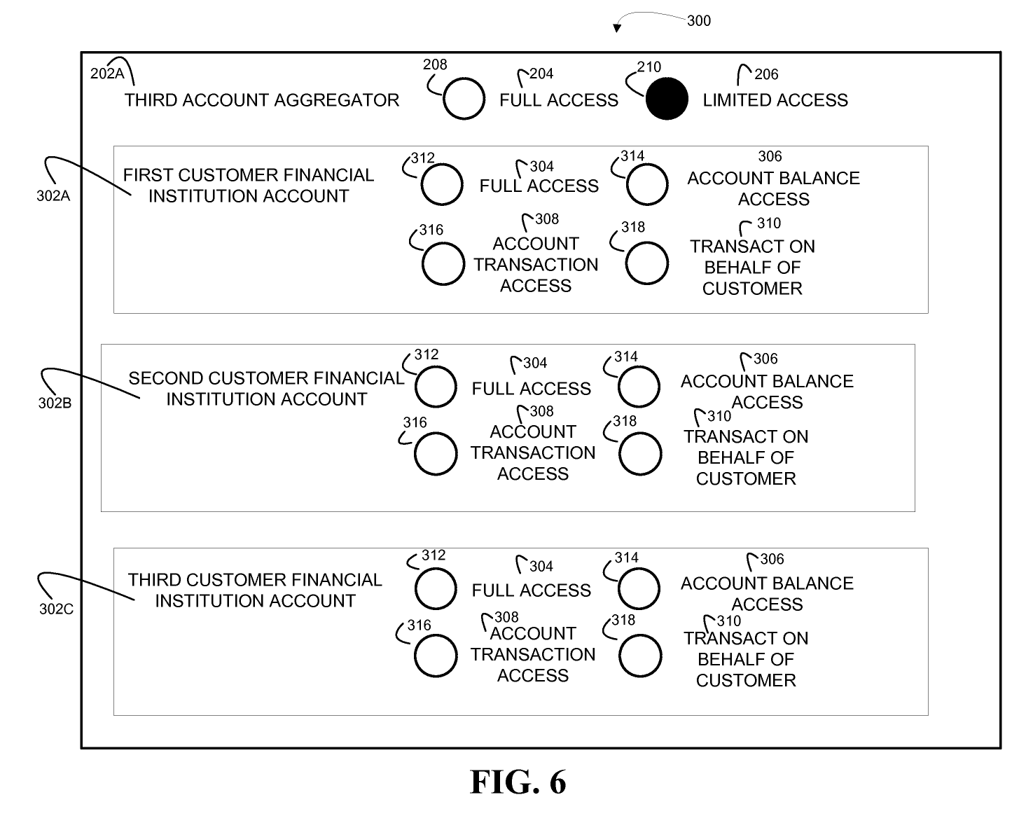

Referring to FIG. 6 a user interface 300 is depicted that is configured to allow the customer to select access parameters for limited account aggregator access, in accordance with embodiments of the present invention. The user interface 300 shown in FIG. 6 may be configured to be accessed by the customer by selecting the limited access permission level (206 of FIGS. 4 and 5). In other embodiments, user interface 300 may be configured to be accessed by the customer through a corresponding menu accessible within the online or mobile banking application. The user interface 300 lists the three financial institution accounts 302A-C, which are currently accessible to the account aggregator and/or the accounts which the account aggregator is functionally configured to access. The customer may individually select the access parameters 304-310 associated with each of the financial institution accounts 302A-C by activating the circles 312-318 associated with the corresponding access parameter. In the illustrated example of FIG. 6 the access parameters include full access 304, account balance access 306, account transaction access 308 and authorization to transact on behalf of the customer 310.

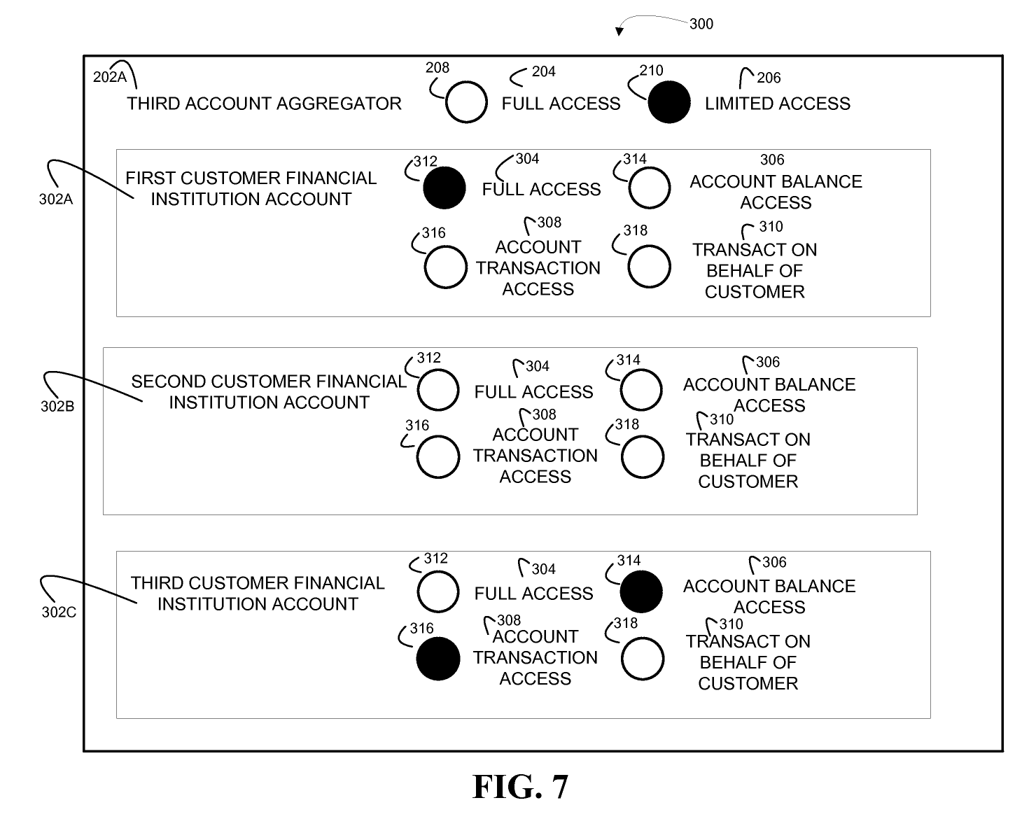

FIG. 7 depicts the same user interface 300 shown in FIG. 6 in which access parameters have been selected for each of the customer financial institution accounts 302A-C. Specifically, first customer financial institution account 302A has been selected for full access 304 by third account aggregator 200C as evident by the activation of corresponding circle 312. Second customer financial institution account 302B has no access parameters selected and, as such, the third account aggregator 200C is not granted any access privileges to information associated with the second customer financial institution account 302B. Third customer financial institution account 302C has been selected for account balance access 306 and account transactions access 308 only as evident by the activation of corresponding circles 314 and 316. It should be noted that the user interface 300 shown in FIG. 7, in which access parameters have been selected by the customer, is the user interface that will initially be displayed to a customer. The selected access parameters may have been selected by the customer during a previous visit to the user interface within the online or mobile banking application. Once the current access parameters are displayed, the customer can choose to change access parameters by activating or deactivating the corresponding circles 312, 314, 316 or 318 associated with the access parameter they desire to activate or deactivate.

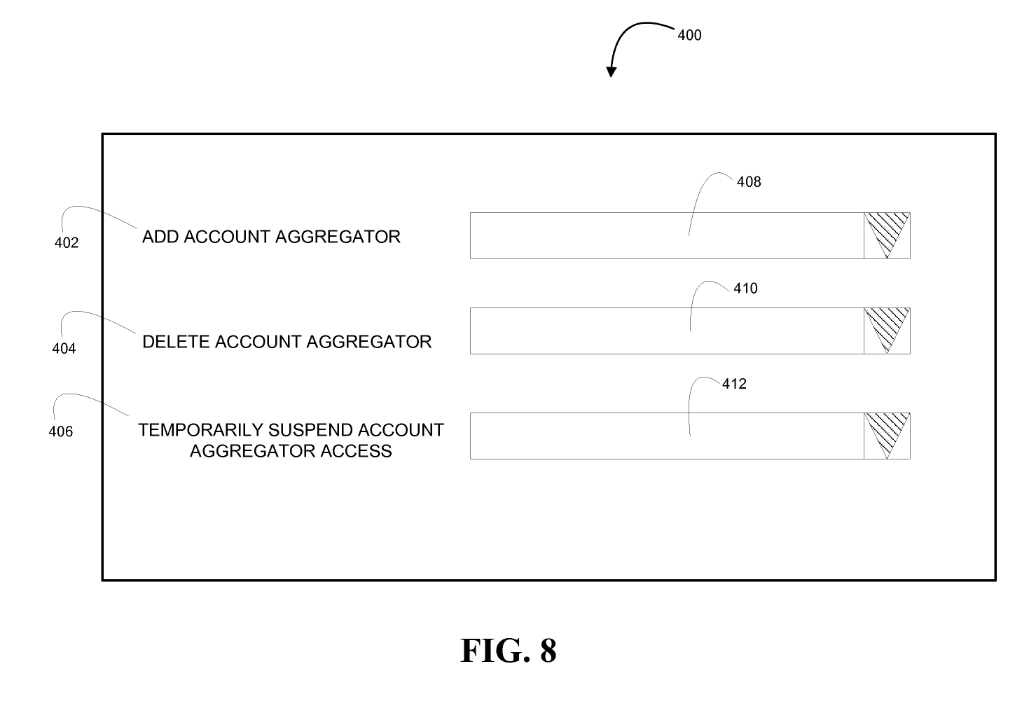

Referring to FIG. 8 a user interface 400 is displayed which is configured to allow the customer to perform other account aggregator management functions, in accordance with additional embodiments of the invention. Specifically, user interface 400 is configured with fields that allow the customer to add an account aggregator 402, delete an account aggregator 404 and/or temporarily suspend an account aggregator from account access 406. Each of the fields 402-406 has a corresponding drop-down menu 408-412 which allows the customer to select an account aggregator for addition, deletion and/or temporary suspension. For example, drop-down menu 408 will list all of the account aggregators affiliated with the financial institution, which do not currently have permission to access the account information and which the customer may desire to provide account access. Drop-down menus 410 and 412 will list the account aggregators which currently have permission to access the account information.

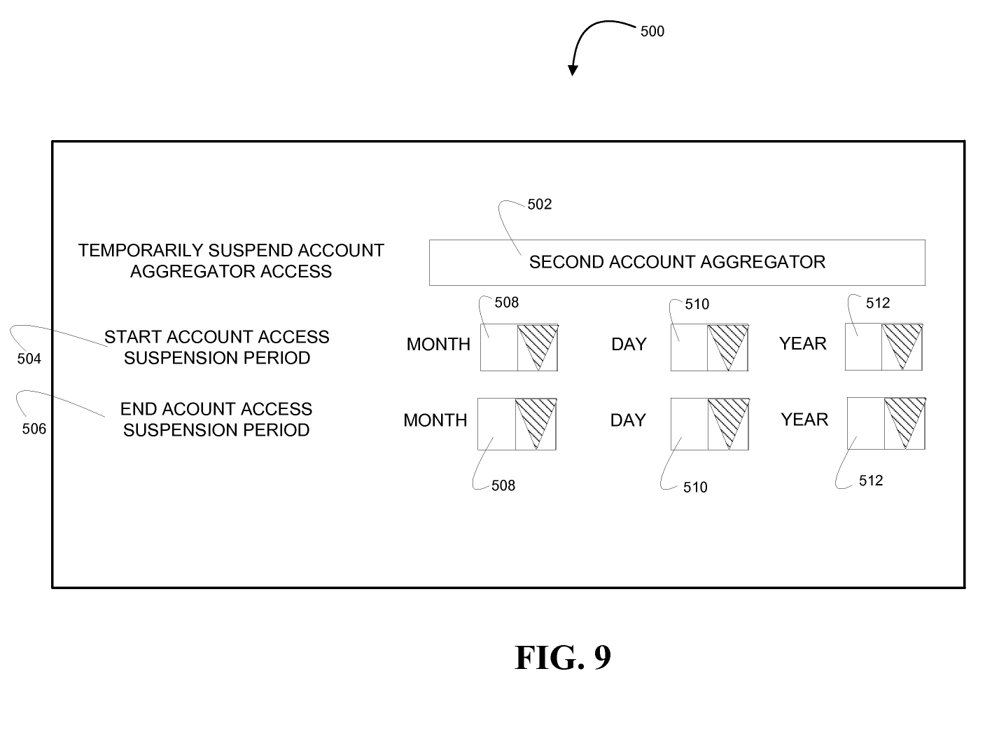

In the event that a customer selects an account aggregator for temporary suspension from account access, the user interface 500 shown in FIG. 9 may be displayed. The user interface 500 indicates in box 502 that the customer has selected second account aggregator for temporary suspension from account access. In addition, user interface 500 is configured to allow the customer to select the time period for suspended account access. Specifically, user interface 500 allows the customer to select a start time 504 for account access suspension and an end time 506 at which the suspension is lifted and the account aggregator is once again granted access to information. In the illustrated embodiment of FIG. 9 drop-down menus 508-512 are provided that allow the customer to select a month, day and year as the start time 504 and the end time 506. The start time drop down menus 508-515 may be pre-configured to show the current date to indicate that the temporary suspension period will start immediately or the customer may change the pre-configured current date to reflect a future date at which the start time of the suspension period will occur.

Thus, the present invention as described in detail above provides for determining and notifying a user, herein a financial institution customer, as to which account aggregators currently have been granted permission to access accounts held by the customer at the financial institution. In addition to notifying the customer of the current status of account aggregator access, the present invention provides the customer, through an online or mobile banking application or the like, a comprehensive tool for managing the access granted to all of the account aggregators that are determined to currently have permission to access the customer's accounts. Such managing of access includes, but is not limited to, granting full access, temporarily or permanently limiting access, temporarily or permanently denying access, and the like.

To supplement the present disclosure, this application further incorporates entirely by reference the following commonly assigned patent applications: U.S. patent application Ser. No. ______ for a “Remote Control for Online Banking,” filed Jul. 19, 2013; U.S. patent application Ser. No. ______ for “Online Banking Alerts,” filed Jul. 19, 2013; U.S. patent application Ser. No. ______ for “Customer-Defined Online Banking Access Restrictions,” filed Jul. 19, 2013; U.S. patent application Ser. No. ______ for “Restricted Access to Online Banking,” filed Jul. 19, 2013; U.S. patent application Ser. No. ______ for “Offline Mobile Banking,” filed Jul. 19, 2013; U.S. patent application Ser. No. ______ for “Completing Mobile Banking Transactions from Trusted Location,” filed Jul. 19, 2013; U.S. patent application Ser. No. ______ for “Completing Mobile Banking Transaction with Different Devices,” filed Jul. 19, 2013; and U.S. patent application Ser. No. ______ for an “Online Session Transfer,” filed Jul. 19, 2013.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for managing account aggregators access to financial institution account data, the apparatus comprising:
a computing platform having a memory and at least one processor in communication with the memory device;
an account aggregator management module stored in the memory, executable by the processor and including:
an account aggregator determining routine configured to determine which account aggregators currently have permission to access information associated with accounts held by a customer at a financial institution,
an account aggregator presentation routine configured to, in response to the customer logging-on to an online or mobile banking application, display account aggregators indicators for each of the account aggregators determined to currently have permission to access the information associated with the accounts held by the customer at the financial institution, and
an account aggregator management user interface routine configured to provide a user interface within the online or mobile banking application that is configured to allow the customer to manage access provided to each of the account aggregators.

2. The apparatus of claim 1, wherein the account aggregator management user interface routine is further configured to provide the user interface that is configured to allow the customer to set an access permission level for each of the account aggregators.

3. The apparatus of claim 2, wherein the account aggregator management user interface routine is further configured to provide the user interface that is configured to allow the customer to set the access permission level as one of limited access or full access for each of the account aggregators.

4. The apparatus of claim 3, wherein the account aggregator management user interface routine is further configured to provide the user interface that is configured to allow the customer to select one or more access parameters for limited access permission.

5. The apparatus of claim 4, wherein the account aggregator management user interface routine is further configured to provide the user interface that is configured to allow the customer to select the one or more access parameters, wherein the access parameters include one or more of (1) access to customer designated accounts; (2) account balance access to customer designated accounts, (3) account transaction access to customer designated accounts, (4) engage in transactions on behalf of the customer from customer designated accounts.

6. The apparatus of claim 1, wherein the account aggregator management user interface routine is further configured to provide the user interface that is configured to allow the customer to add or delete an account aggregator, such that the added account aggregator is granted permission to access the information associated with the accounts held by the customer at the financial institution and the deleted account aggregator is denied further access to the information associated with the accounts held by the customer at the financial institution.

7. The apparatus of claim 1, wherein the account aggregator management user interface routine is further configured to provide the user interface that is configured to allow the customer to temporarily suspend access to an account aggregator for a customer-designated period of time.

8. The apparatus of claim 1, wherein the account aggregator presentation routine is further configured to display the account aggregator indicators constantly during the online or mobile banking session.

9. The apparatus of claim 8, wherein the account aggregator presentation routine is further configured to provide the customer access to the user interface through activation of the account aggregator indicators.

10. A method for managing account aggregators access to financial institution account data, the method comprising:
determining, by a computing device processor, which account aggregators currently have permission to access information associated with accounts held by a customer at a financial institution,
in response to the customer logging-on to an online or mobile banking application, displaying, by a computing device processor, account aggregators indicators for each of the account aggregators determined to currently have permission to access the information associated with the accounts held by the customer at the financial institution; and
providing, by a computing device processor, a user interface within the online or mobile banking application that is configured to allow the customer to manage access provided to each of the account aggregators.

11. The method of claim 10, wherein providing the user interface further comprises providing, by the computing device processor, the user interface that is configured to allow the customer to set an access permission level for each of the account aggregators.

12. The method of claim 11, wherein providing the user interface further comprises providing, by the computing device processor, the user interface that is configured to allow the customer to set the access permission level as one of limited access or full access for each of the account aggregators.

13. The method of claim 12, wherein providing the user interface further comprises providing, by the computing device processor, the user interface that is configured to allow the customer to select one or more access parameters for limited access permission.

14. The method of claim 13, wherein providing the user interface further comprises providing, by the computing device processor, the user interface that is configured to allow the customer to select the one or more access parameters, wherein the access parameters include one or more of (1) access to customer designated accounts; (2) account balance access to customer designated accounts, (3) account transaction access to customer designated accounts, (4) engage in transactions on behalf of the customer from customer designated accounts.

15. The method of claim 10, wherein providing the user interface further comprises providing, by the computing device processor, the user interface that is configured to allow the customer to add or delete an account aggregator, such that the added account aggregator is granted permission to access the information associated with the accounts held by the customer at the financial institution and the deleted account aggregator is denied further access to the information associated with the accounts held by the customer at the financial institution.

16. The method of claim 10, wherein providing the user interface further comprises providing, by the computing device processor, the user interface that is configured to allow the customer to temporarily suspend access to an account aggregator for a customer-designated period of time.

17. The method of claim 10, wherein displaying further comprises, displaying, by the computing device processor, the account aggregator indicators constantly during the online or mobile banking session.

18. The method of claim 17, further comprising providing, by a computing device processor, the customer access to the user interface through activation of the account aggregator indicators.

19. A computer program product comprising:
a non-transitory computer-readable medium comprising:
a first set of codes for causing a computer to determine which account aggregators currently have permission to access information associated with accounts held by a customer at a financial institution,
a second set of codes for causing a computer to, in response to the customer logging-on to an online or mobile banking application, display account aggregators indicators for each of the account aggregators currently having permission to access the information associated with the accounts held by the customer at the financial institution; and
a third set of codes for causing a computer to provide a user interface within the online or mobile banking application that is configured to allow the customer to manage access provided to each of the account aggregators.

20. The computer program product of claim 19, wherein the third set of codes is further configured to cause the computer to provide the user interface that is configured to allow the customer to set an access permission level for each of the account aggregators.

21. The computer program product of claim 20, wherein the third set of codes is further configured to cause the computer to provide the user interface that is configured to allow the customer to set the access permission level as one of limited access or full access for each of the account aggregators.

22. The computer program product of claim 21, wherein the third set of codes is further configured to cause the computer to provide the user interface that is configured to allow the customer to select one or more access parameters for limited access permission.

23. The computer program product of claim 22, wherein the third set of codes is further configured to cause the computer to provide the user interface that is configured to allow the customer to select the one or more access parameters, wherein the access parameters include one or more of (1) access to customer designated accounts; (2) account balance access to customer designated accounts, (3) account transaction access to customer designated accounts, (4) engage in transactions on behalf of the customer from customer designated accounts.

24. The computer program product of claim 22, wherein the third set of codes is further configured to cause the computer to provide the user interface that is configured to allow the customer to add or delete an account aggregator, such that the added account aggregator is granted permission to access the information associated with the accounts held by the customer at the financial institution and the deleted account aggregator is denied further access to the information associated with the accounts held by the customer at the financial institution.

25. The computer program product of claim 19, wherein the third set of codes is further configured to cause the computer to provide the user interface that is configured to allow the customer to temporarily suspend access to an account aggregator for a customer-designated period of time.

26. The computer program product of claim 19, wherein the second set of codes is further configured to cause the computer to display the account aggregator indicators constantly during the online or mobile banking session.

27. The computer program product of claim 26, further comprising a fourth set of codes for causing a computer to provide the customer access to the user interface through activation of the account aggregator indicators.
